(19) United States
(12) Patent Application Publication
(10) Pub. No.: US 2016/0096555 A1
(43) Pub. Date: Apr. 7, 2016

(54) AERODYNAMIC TRACTOR-TRAILER GAP REDUCER AND ASSEMBLY THEREOF

(71) Applicants: Swaroop Mulenahalli KANTHARAJU, Montreal (CA); Georges BASSILY, Laval (CA); Mathieu BOIVIN, Saint-Laurent (CA)

(72) Inventors: Swaroop Mulenahalli KANTHARAJU, Montreal (CA); Georges BASSILY, Laval (CA); Mathieu BOIVIN, Saint-Laurent (CA)

(73) Assignee: TRANSTEX COMPOSITE INC., Ville St-Laurent (CA)

(21) Appl. No.: 14/870,780

(22) Filed: Sep. 30, 2015

Related U.S. Application Data
(60) Provisional application No. 62/091,546, filed on Dec. 14, 2014.
(60) Provisional application No. 62/059,125, filed on Oct. 2, 2014.

(51) Int. Cl. B62D 35/00; B62D 39/00

(52) U.S. Cl. CPC B62D 35/001; B62D 39/00

(57) ABSTRACT

This invention relates to a gap-reducer for reducing a gap between a road tractor and a trailer attached thereto, the gap-reducer comprising a top portion and a bottom portion, the bottom portion being located further forward than the top portion when the gap-reducer is secured on the trailer in an operating position. The gap-reducer extending over the width of the trailer to reduce the drag of the trailer.

### CROSS-REFERENCE

The present application relates to and is a non-provisional application of U.S. Patent application No. 62/059,125, filed Oct. 2, 2014, entitled AERODYNAMIC TRACTOR-TRAILER GAP REDUCER AND ASSEMBLY THEREOF, the present application also relates to and is a non-provisional application of U.S. Patent application No. 62/094,543, filed Dec. 19, 2014, entitled AERODYNAMIC TRACTOR-TRAILER GAP REDUCER AND ASSEMBLY THEREOF. Both documents are incorporated herein by reference in their entireties.

### FIELD OF THE INVENTION

This invention relates to an aerodynamic gap reducer adapted to be mounted on a trailer to improve the aerodynamic efficiency of a vehicle by reducing a gap between a road tractor and its associated trailer.

### BACKGROUND OF THE INVENTION

Road tractors are generally used to pull trailers on roads to transport cargo. Aerodynamic apparatuses can be installed on the road tractor and/or on the trailer in order to reduce the aerodynamic air drag and improve fuel efficiency.

Trailer gap-reducers are generally installed on the front portion of the trailer in order to reduce the gap between the road tractor pulling the trailer and the trailer in order to reduce the aerodynamic air drag and improve fuel efficiency.

The shape of the aerodynamic gap-reducer has an effect on the aerodynamic efficiency of the gap-reducer and on its interaction with the road tractor operatively and movably connected to the trailer. The shape of the aerodynamic gap-reducer has an effect on the mechanical strength and the sturdiness of the gap-reducer and also has an effect on the method that is used to secure the gap-reducer to the trailer.

Therefore, there exists a need in the art for an improved aerodynamic gap-reducer assembly over the existing art. There is a need in the art for such an aerodynamic gap-reducer that improves the fuel economy of a vehicle. There is also a need for an aerodynamic gap-reducer that is light and rigid. There is a need for an aerodynamic gap-reducer that can be easily mounted on a front portion of a trailer. Moreover, there is also a need for an aerodynamic gap-reducer that can be mounted on trailers of different shapes.

### SUMMARY OF THE INVENTION

It is one aspect of the present invention to alleviate one or more of the drawbacks of the background art by addressing one or more of the existing needs in the art.

Accordingly, an aspect of our work, in accordance with at least one embodiment thereof, provides an improved aerodynamic gap-reducer over the prior art.

An aspect of our work, in accordance with at least one embodiment thereof, provides an aerodynamic gap-reducer adapted to be installed on a trailer to reduce the aerodynamic drag produced by the movement of the trailer when pulled by a road tractor.

An aspect of our work, in accordance with at least one embodiment thereof, provides an aerodynamic gap-reducer assembly that is adapted to fill a gap between a road tractor and a trailer and minimize the gap therebetween while allowing free relative movements thereof.

An aspect of our work, in accordance with at least one embodiment thereof, provides an aerodynamic gap-reducer that can be easily installed and economically manufactured.

An aspect of our work, in accordance with at least one embodiment thereof, provides a gap reducer that laterally covers a trailer front face completely from one side to another leaving no space for air to impact trailer front face and create pressure drag while still giving access to glad hands and power hoses on the trailer front face.

An aspect of our work, in accordance with at least one embodiment thereof, provides an aerodynamic gap-reducer assembly that has a more efficient aerodynamic shape than prior art aerodynamic gap-reducer.

An aspect of our work, in accordance with at least one embodiment thereof, provides an aerodynamic gap-reducer that includes ribs and/or reinforcements therein, visible and/or invisible from the outside of the aerodynamic gap-reducer, to increase stiffness with a thin wall construction.

An aspect of our work, in accordance with at least one embodiment thereof, provides an aerodynamic gap-reducer configured to be efficiently and easily secured to a trailer.

An aspect of our work, in accordance with at least one embodiment thereof, provides an aerodynamic gap-reducer assembly that is sized and designed to prevent reducing the cargo space of the trailer.

An aspect of our work, in accordance with at least one embodiment thereof, provides an aerodynamic gap-reducer assembly that is secured to the exterior walls of a trailer to prevent reducing the cargo space inside the trailer.

An aspect of our work, in accordance with at least one embodiment thereof, provides an aerodynamic gap-reducer assembly that allows receiving therein two cargo pallets within the aerodynamic gap-reducer interior width.

An aspect of our work, in accordance with at least one embodiment thereof, provides an aerodynamic gap-reducer that has a front axial lower portion extending forward of the front axial upper portion to improve the aerodynamics of the vehicle.

An aspect of our work, in accordance with at least one embodiment thereof, provides an aerodynamic gap-reducer that has low sensitivity to lateral winds.

An aspect of our work, in accordance with at least one embodiment thereof, provides an aerodynamic gap-reducer including a lower flange designed to be secured on an uneven front face of a trailer.

An aspect of our work, in accordance with at least one embodiment thereof, provides an aerodynamic gap-reducer including a lower flange having various thicknesses for easily matching the exterior shape of a trailer.

An aspect of our work, in accordance with at least one embodiment thereof, provides an aerodynamic gap-reducer including matching corners thereof that can be adapted to specific shapes of trailers' corners. The matching corners of the aerodynamic gap-reducer can be, inter alia, pre-cut, modular, replaceable, marked for design reference.

An aspect of our work, in accordance with at least one embodiment thereof, provides an aerodynamic gap-reducer made of composite materials offering a significant range of elastic deformation.

An aspect of our work, in accordance with at least one embodiment thereof, provides an aerodynamic gap-reducer made of non-metallic material.

An aspect of our work, in accordance with at least one embodiment thereof, provides an aerodynamic gap-reducer assembly configured to allow a temporary elastic deflection upon contact of a foreign object and recovering its original shape when not in contact with the foreign object.

An aspect of our work, in accordance with at least one embodiment thereof, provides a fastening system for easily securing the aerodynamic gap-reducer to the trailer; the fastening system uses a limited number of parts to reduce the assembly time and the weight added to the trailer.

An aspect of our work, in accordance with at least one embodiment thereof, provides a gap-reducer for reducing a gap between a road tractor and a trailer attached thereto, the gap-reducer comprising a top portion, a bottom portion, a forward portion between the top portion and the bottom portion and a pair of side portions interconnected by the forward portion, the gap-reducer being sized and designed to transversally extend over a width of the trailer and provide the side portions in substantially parallel position with side walls of the trailer.

An aspect of our work, in accordance with at least one embodiment thereof, provides a trailer including a gap-reducer for reducing a gap between a road tractor and the trailer attached thereto, the gap-reducer comprising a top portion, a bottom portion, a forward portion between the top portion and the bottom portion and a pair of side portions interconnected by the forward portion, the gap-reducer being sized and designed to transversally extend over a width of the trailer and provide the side portions in substantially parallel position with side walls of the trailer.

Other embodiments and further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which form a part of this original disclosure:

FIG. 1 is a left side elevation view of a tractor and a trailer in accordance with at least one embodiment of the invention;

FIG. 2 is a front-left perspective view of a tractor and a trailer in accordance with at least one embodiment of the invention;

FIG. 3 is a front-left perspective view of a trailer in accordance with at least one embodiment of the invention;

FIG. 4 is a front-left perspective view of an aerodynamic gap-reducer in accordance with at least one embodiment of the invention;

FIG. 5 is a front-left perspective view of a tractor and a trailer in accordance with at least one embodiment of the invention;

FIG. 6 is a rear-left perspective view of a tractor and a trailer in accordance with at least one embodiment of the invention;

FIG. 7 is a left elevation view of an aerodynamic gap-reducer in an operating condition on the trailer, in accordance with at least one embodiment of the invention;

FIG. 8 is a rear-left perspective view of an aerodynamic gap-reducer in an operating condition on the trailer, in accordance with at least one embodiment of the invention;

FIG. 9 is a front-left perspective view of an aerodynamic gap-reducer in an operating condition on the trailer, in accordance with at least one embodiment of the invention;

FIG. 10 is a front elevation view of an aerodynamic gap-reducer, in accordance with at least one embodiment of the invention;

FIG. 11 is a top plan view of an aerodynamic gap-reducer, in accordance with at least one embodiment of the invention;

FIG. 12 is a front elevation view of an aerodynamic gap-reducer, in accordance with at least one embodiment of the invention;

FIG. 13 is a left side elevation view of an aerodynamic gap-reducer, in accordance with at least one embodiment of the invention;

FIG. 14 is a front-left isometric view of an aerodynamic gap-reducer, in accordance with at least one embodiment of the invention;

FIG. 15 is a top plan view of an aerodynamic gap-reducer, in accordance with at least one embodiment of the invention;

FIG. 16 is a front elevation view of an aerodynamic gap-reducer, in accordance with at least one embodiment of the invention;

FIG. 17 is a left side elevation view of an aerodynamic gap-reducer, in accordance with at least one embodiment of the invention;

FIG. 18 is a front-left isometric view of an aerodynamic gap-reducer, in accordance with at least one embodiment of the invention;

FIG. 19 is a left side elevation view of an aerodynamic gap-reducer, in accordance with at least one embodiment of the invention;

FIG. 20 is a front-left isometric view of an aerodynamic gap-reducer, in accordance with at least one embodiment of the invention;

FIG. 21 is a top plan view of an aerodynamic gap-reducer, in accordance with at least one embodiment of the invention;

FIG. 22 is a front elevation view of an aerodynamic gap-reducer, in accordance with at least one embodiment of the invention;

FIG. 23 is a left side elevation view of an aerodynamic gap-reducer, in accordance with at least one embodiment of the invention;

FIG. 24 is a front-left isometric view of an aerodynamic gap-reducer, in accordance with at least one embodiment of the invention;

FIG. 25 is a rear-left isometric view of an aerodynamic gap-reducer, in accordance with at least one embodiment of the invention;

FIG. 26 a front elevation view of an aerodynamic gap-reducer, in accordance with at least one embodiment of the invention;

FIG. 27 is a top plan view of an aerodynamic gap-reducer, in accordance with at least one embodiment of the invention;

FIG. 28 is a left side elevation view of an aerodynamic gap-reducer, in accordance with at least one embodiment of the invention;

FIG. 29 is a rear-left isometric view of an aerodynamic gap-reducer, in accordance with at least one embodiment of the invention;

FIG. 30 a) is a schematic top plan illustration of a forward portion of a trailer;

FIG. 30 b) is a schematic top plan illustration of a forward portion of a trailer;

FIG. 31 is a rear-left perspective view of the lower portion of an aerodynamic gap-reducer, in accordance with at least one embodiment of the invention;

FIG. 32 is a front-bottom perspective view of an aerodynamic gap-reducer, in accordance with at least one embodiment of the invention;

FIG. 33 is a front-left perspective view of an aerodynamic gap-reducer in an operating condition on the trailer, in accordance with at least one embodiment of the invention;

FIG. 34 is a front elevation view of an aerodynamic gap-reducer in an operating condition on the trailer, in accordance with at least one embodiment of the invention;

FIG. 35 is a left side elevation view of an aerodynamic gap-reducer in an operating condition on the trailer, in accordance with at least one embodiment of the invention;

FIG. 36 is a left side elevation view of an aerodynamic gap-reducer in an operating condition on the trailer, in accordance with at least one embodiment of the invention;

FIG. 37 is a front-left perspective view of an aerodynamic gap-reducer in an operating condition on the trailer, in accordance with at least one embodiment of the invention;

FIG. 38 a) is a schematic top plan illustration of a forward portion of a trailer;

FIG. 38 b) is a schematic top plan illustration of a forward portion of a trailer;

FIG. 39 is a front-left perspective view of a corner of a trailer;

FIG. 40 is a front-left perspective view of a corner of a trailer;

FIG. 41 is a rear-left perspective view of a portion of an aerodynamic gap-reducer, in accordance with at least one embodiment of the invention;

FIG. 42 is a rear-left perspective view of a portion of an aerodynamic gap-reducer, in accordance with at least one embodiment of the invention;

FIG. 43 is a rear-left perspective view of a portion of an aerodynamic gap-reducer, in accordance with at least one embodiment of the invention;

FIG. 44 is a rear-left perspective view of a portion of an aerodynamic gap-reducer, in accordance with at least one embodiment of the invention;

FIG. 45 is a rear-left perspective view of a portion of an aerodynamic gap-reducer, in accordance with at least one embodiment of the invention;

FIG. 46 is a rear-left perspective view of a portion of an aerodynamic gap-reducer, in accordance with at least one embodiment of the invention;

FIG. 47 is a rear-left perspective view of a portion of an aerodynamic gap-reducer, in accordance with at least one embodiment of the invention;

FIG. 48 is a left side elevation view of an aerodynamic gap-reducer in an operating condition on the trailer, in accordance with at least one embodiment of the invention;

FIG. 49 is a right side elevation view of an aerodynamic gap-reducer in an operating condition on the trailer, in accordance with at least one embodiment of the invention;

FIG. 50 is a left side elevation view of an aerodynamic gap-reducer in an operating condition on the trailer, in accordance with at least one embodiment of the invention;

FIG. 51 is a left side elevation view of an aerodynamic gap-reducer in an operating condition on the trailer, in accordance with at least one embodiment of the invention;

FIG. 52 is a left side elevation view of an aerodynamic gap-reducer in an operating condition on the trailer, in accordance with at least one embodiment of the invention;

FIG. 53 is a left side elevation view of an aerodynamic gap-reducer in an operating condition on the trailer, in accordance with at least one embodiment of the invention;

FIG. 54 is a left side elevation view of an aerodynamic gap-reducer in an operating condition on the trailer, in accordance with at least one embodiment of the invention;

FIG. 55 is a top plan view of an aerodynamic gap-reducer in an operating condition on the trailer, in accordance with at least one embodiment of the invention;

FIG. 56 is a top plan view of a prior art aerodynamic gap-reducer in an operating condition on the trailer;

FIG. 57 is a top plan view of an aerodynamic gap-reducer in an operating condition on the trailer, in accordance with at least one embodiment of the invention;

FIG. 58 is a front-left side perspective view of an aerodynamic gap-reducer, in accordance with at least one embodiment of the invention; and

FIG. 59 is a front-left side perspective view of an aerodynamic gap-reducer, in accordance with at least one embodiment of the invention;

### DETAILED DESCRIPTION OF PREFERRED EMBODIMENTS

A preferred embodiment of the present invention is described bellow with reference to the drawings.

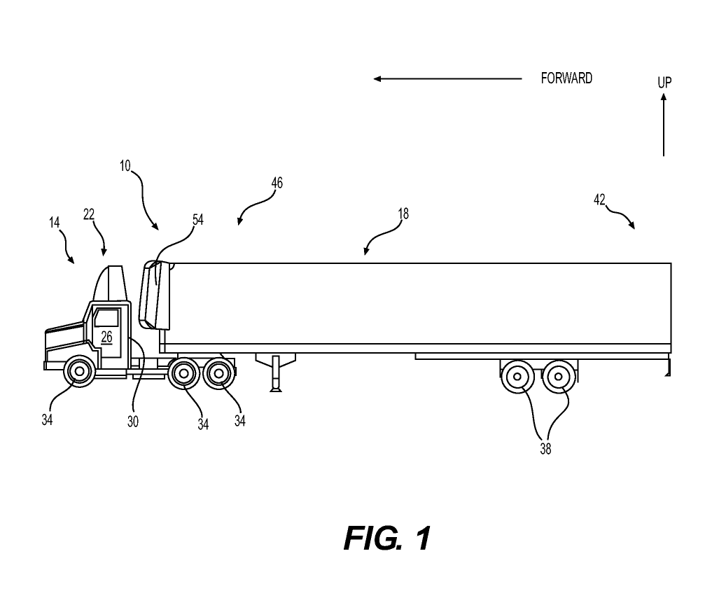

FIG. 1 illustrates a vehicle 10 comprising a road tractor 14 operatively connected to a trailer 18. The road tractor 14 includes a cab 22 accessible through a door 26. The cab 22 includes a rear wall 30 facing the trailer 18. The road tractor 14 is equipped with a set of wheels 34 adapted to steer and propel the vehicle 10. The trailer 18 also includes a set of wheels 38 generally disposed near the rear portion 42 thereof. The trailer 18 includes a front portion 46 thereof and opposed lateral sides 50 thereof.

The trailer 18 includes an aerodynamic gap-reducer 54 on its front portion 46. The aerodynamic gap-reducer 54 can be embodied in various configurations. For instance, in an OEM configuration, the aerodynamic gap-reducer 54 is built with the trailer 18 in an operating position. In contrast, in an add-on configuration, the aerodynamic gap-reducer 54 is added to the trailer 18 and secured to its outside surface in the operating position. The illustrative embodiment that is going to be discussed is an aerodynamic gap-reducer 54 in the add-on configuration. The illustrative embodiment is not intended to be limitative thereof and no disclaimer is made in regard of other possible alternate configurations. As it can be appreciated, the aerodynamic gap-reducer 54 is located between the road tractor 14 and the trailer 18 to reduce the gap therebetween. Reducing the gap between the road tractor 14 and the trailer 18 helps channel the air around the vehicle 10 and provides a smoother ride that reduce the drag of the vehicle 10 hence reducing the fuel consumption of the vehicle 10.

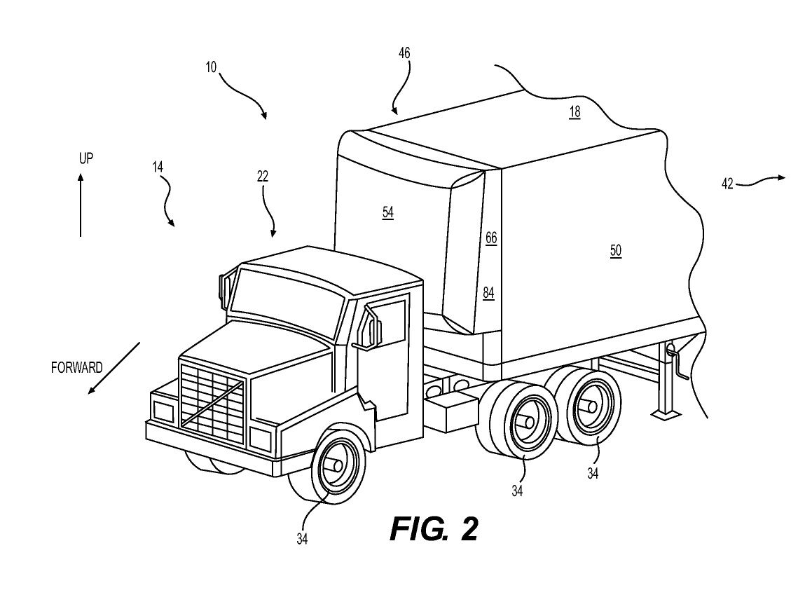

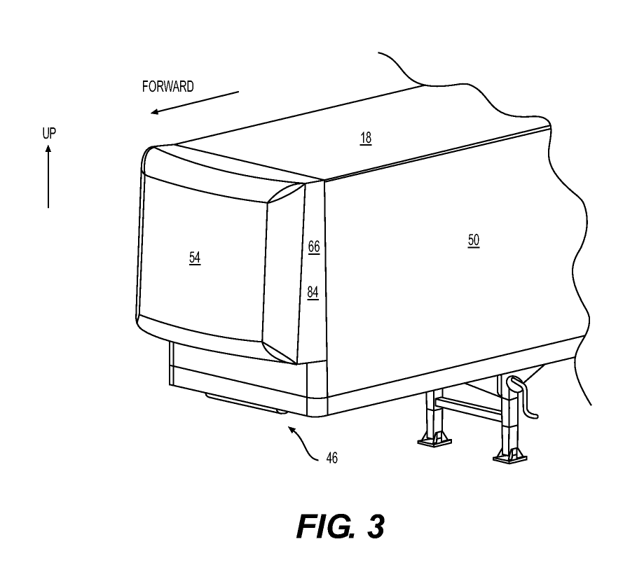

FIG. 2, with the tractor 14, and FIG. 3, without the tractor 14, illustrate the front portion 46 of the trailer 18 in greater details. It is shown the gap reducer 54 covers completely the front portion of the trailer 18 leaving no flat surfaces of the trailer 18 over the width of the front face of the trailer 18. This allows smoother routing of air by preventing the flow of air to impact the front face of the trailer 18 and create pressure drag. The gap reducer 54 includes a pair of substantially opposed side flanges 84 rearwardly extending from respective sides of the gap reducer 54 to superpose the sides of the trailer 18. In an embodiment, the side flanges 84 are extending parallely from the sides of the trailer 18.

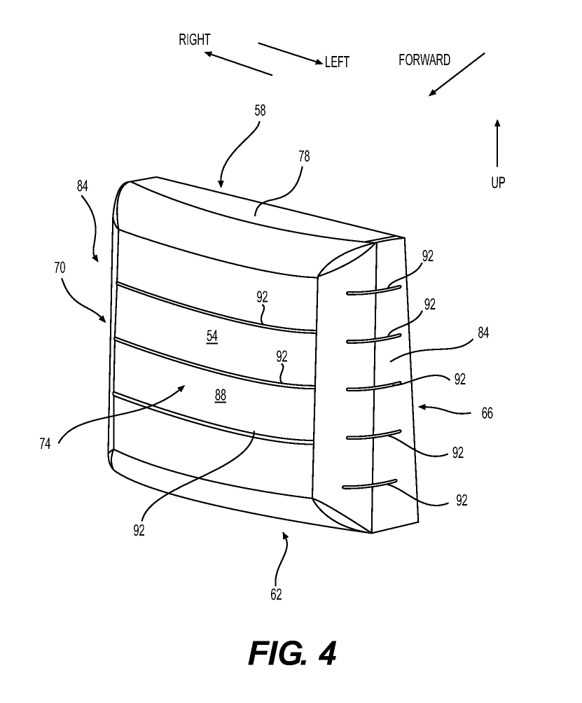

As illustrated in FIG. 4, the aerodynamic gap-reducer 54 includes a top portion 58, a bottom portion 62, a first side portion 66, a second side portion 70 and a front portion 74. The aerodynamic gap-reducer 54 further includes a top flange 78, side flanges 84 and a center bulge 88. A series of reinforcement ribs 92 is also part of the aerodynamic gap-reducer 54 to increase its rigidity while minimizing its weight.

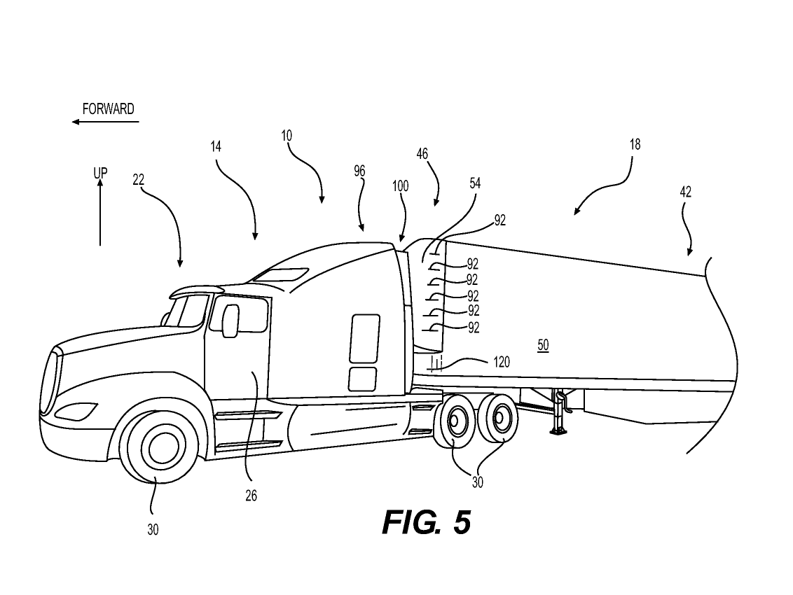

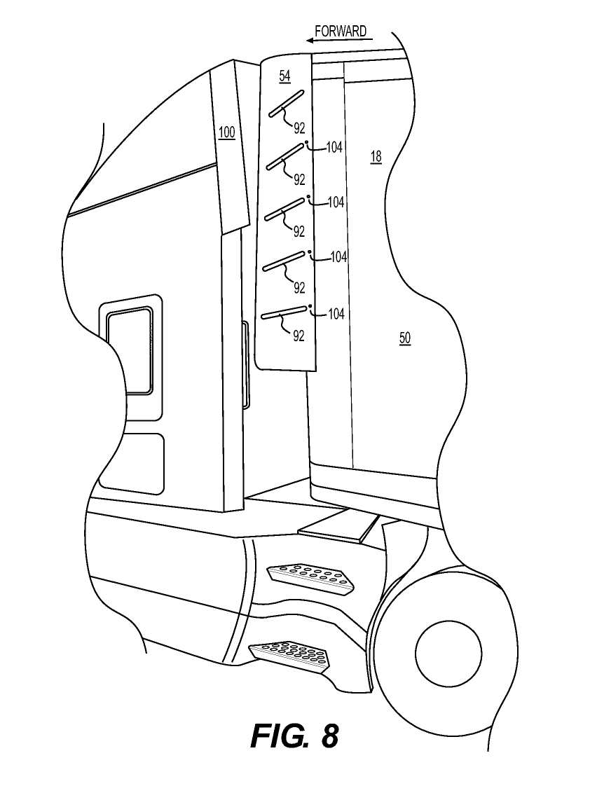

FIG. 5 throughout FIG. 8 are depicting an aerodynamic gap-reducer 54 in the operating position installed on a trailer 18 between a road tractor 14 and the trailer 18. One can appreciate the road tractor 14 is equipped with a sleeper extension 96 including side wind fairings 100. It can be appreciated that the aerodynamic gap-reducer 54 is secured to the sides of the trailer 18 with a series of fasteners 104 that could be embodied as rivets, bolts, glue, welding, Velcro, among others. The series of reinforcement ribs 92 is shown on the sides of the aerodynamic gap-reducer 54 protruding from the exterior surface of the aerodynamic gap-reducer 54 to increase rigidity of the aerodynamic gap-reducer 54 and also to help direct the flow of air.

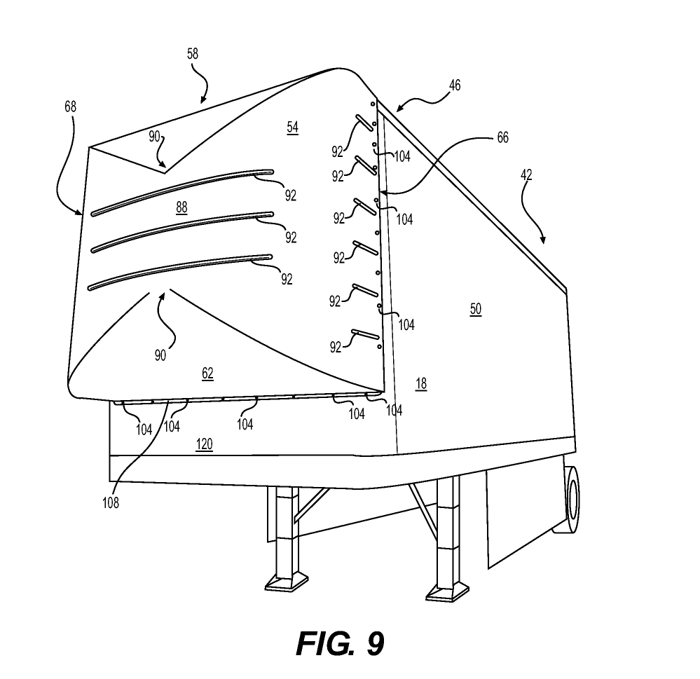

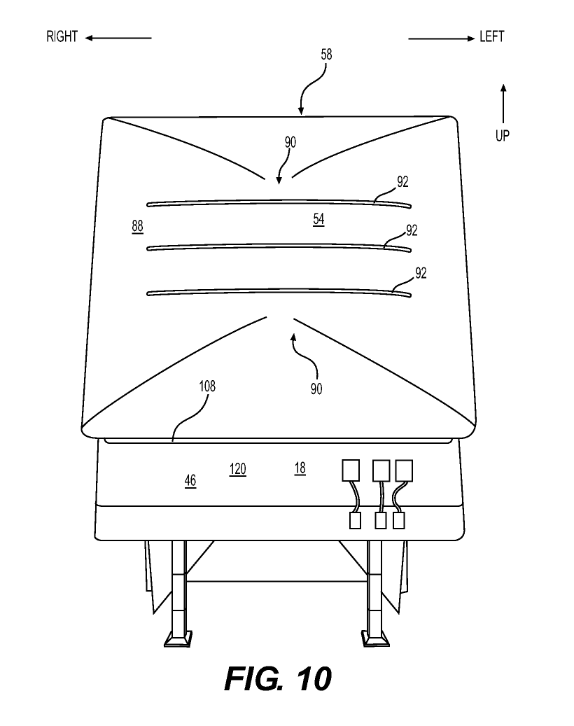

A trailer 18 without the tractor 14 is illustrated in FIG. 9 and FIG. 10. One can appreciate the aerodynamic gap-reducer 54 disposed on the front portion 46 of the trailer 18, covering the entire width of the trailer 18. It is possible to see a flange 108 near the lower portion of the aerodynamic gap-reducer 54 to offer a substantially flat surface offering a reasonable portion to receive the fasteners and secure the lowest portion of the aerodynamic gap-reducer 54 to the trailer 18. The flange 108 is sized and designed to facilitate securing the aerodynamic gap-reducer 54 on the front portion 46 of the trailer 18 and to allow some bending properties to match the shape of the front face wall 120 of the trailer 18.

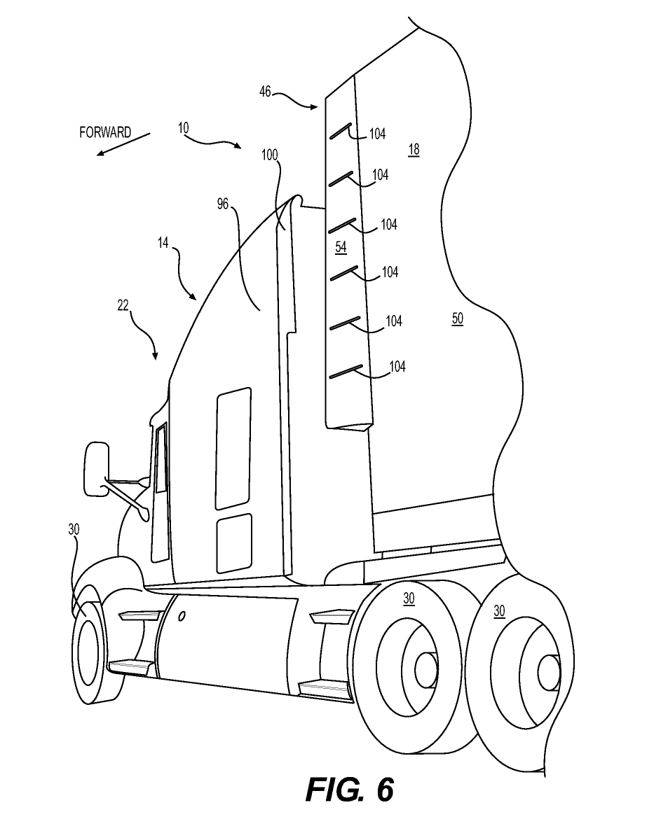

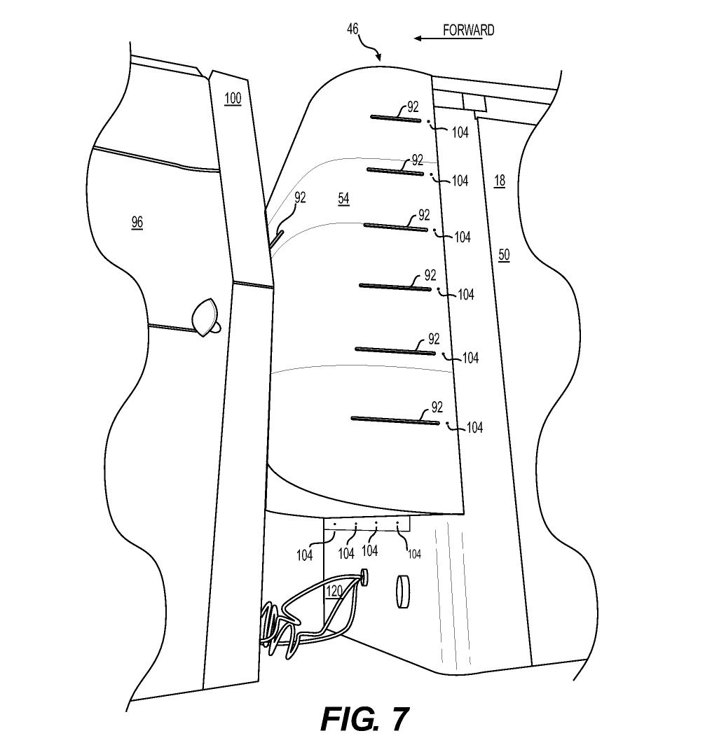

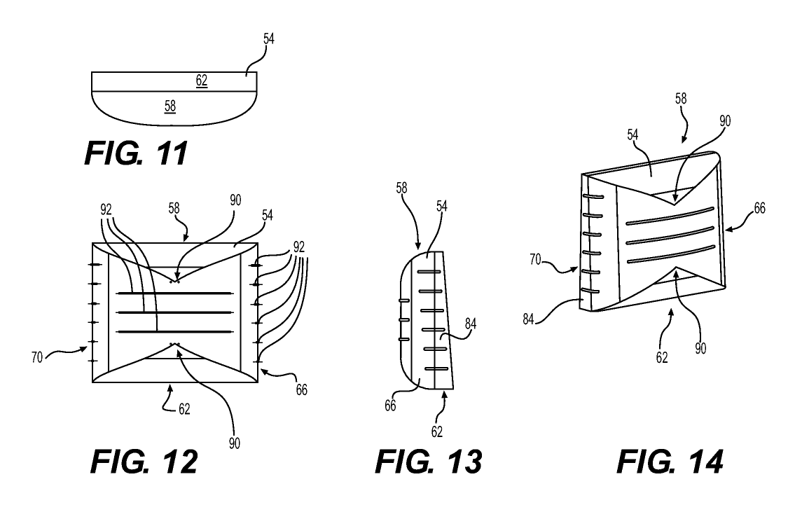

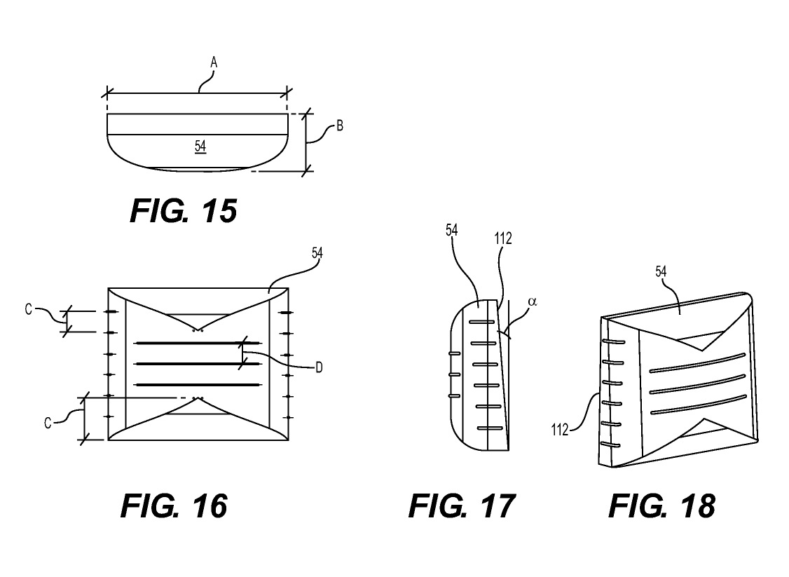

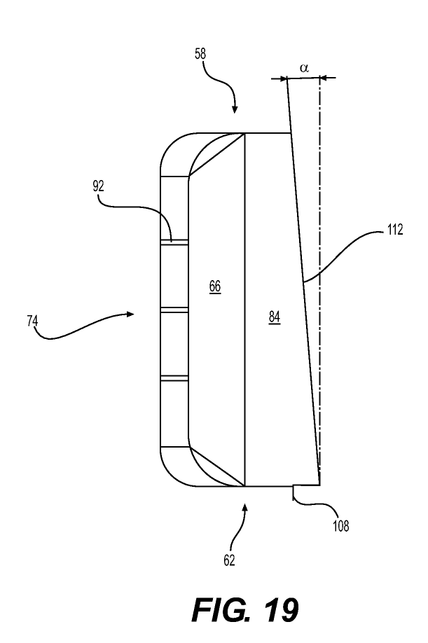

FIG. 11 throughout FIG. 14 are additional views of the aerodynamic gap-reducer 54 including a top projection 90 and bottom projection 90 as well identified in FIG. 6 throughout FIG. 10. The top projection 90 and bottom projection 90 allow to collect air toward the middle of the bulge 88 of the aerodynamic gap-reducer 54 and channel the flow of air toward the top and the bottom of the trailer 18. The top projection 90 and bottom projection 90 are allowing high and complete side portions 66, 70 to collect air on the entire sides of the aerodynamic gap-reducer 54. The bottom portion 62 of the aerodynamic gap-reducer 54 is longitudinally longer than the upper portion 58 to provide an angle α from a profile 94 of the bulge 88 that is better seen in FIG. 19 below. The edge 112, designed at angle α from the profile 94 of the bulge 88 of the aerodynamic gap-reducer 54, is going to be generally vertical when mounted on the trailer 18 and the angle α is going to locate the bottom portion 62 more forwardly than the top portion 58. The angle α is between a two degree angle (2°) and a ten degree angle (10°). Preferably about a five degree angle (5°) and ideally about four point nine degree angle)(4.9°. More precisely, FIG. 15 throughout FIG. 17 are illustrating the same gap reducer 54 as in FIG. 11 throughout FIG. 18 with exemplary dimensions. A=about 259 cm (about 102 inches), B=about 81.3 cm (about 32 inches), C=about 30.5 cm (about 12 inches), and D=about 30.5 cm (about 12 inches).

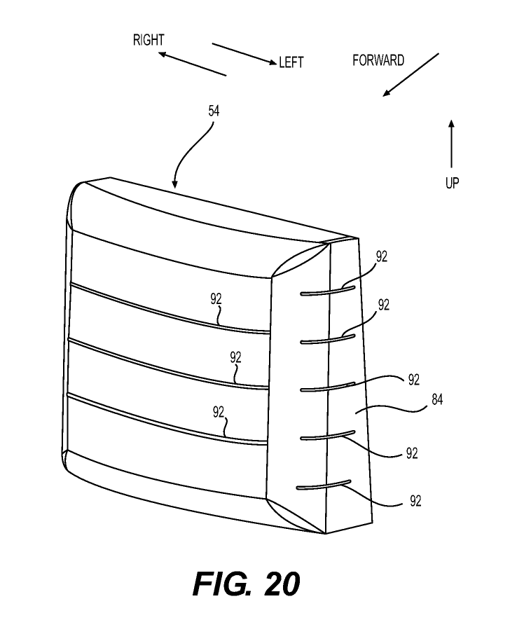

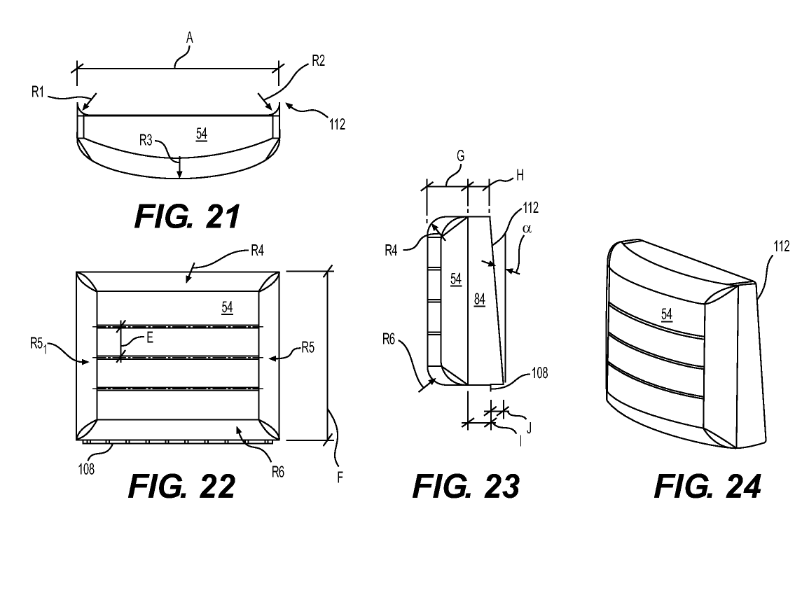

FIG. 20 is illustrating another possible embodiment of the aerodynamic gap-reducer 54 that was previously shown in FIG. 4. This embodiment has no angular projection 90 like the previous embodiment and includes a plurality of external reinforcement ribs 92 extending across the aerodynamic gap-reducer 54. The external ribs 92 can be visible for aerodynamic purposes as much as for aesthetic purposes but could alternatively be located inside the aerodynamic gap-reducer 54 and not be visible without departing from the scope of the present application. This embodiment of the aerodynamic gap-reducer 54 is more precisely depicted in FIG. 21 throughout FIG. 24 that are illustrating the same aerodynamic gap reducer 54 as shown in FIG. 19 and FIG. 20 with exemplary approximated dimensions. A=about 259 cm (about 102 inches), E=about 40.6 cm (about 16 inches), F=about 218.4 cm (about 86 inches), G=about 50.8 cm (about 20 inches), H=about 29.2 cm (about 11.5 inches), 1=about 30.5 cm (about 12 inches) and J=about 16.5 cm (about 6.5 inches). Exemplary radiuses: R1=about cm (about 14 inches), R2=about 14 cm (about 5.5 inches), R3=about 330.2 cm (about 130 inches), R4=about 25.4 cm (about 10 inches), R5=about 38.1 cm (about 15 inches) and R6=about 24.5 cm (about 10 inches).

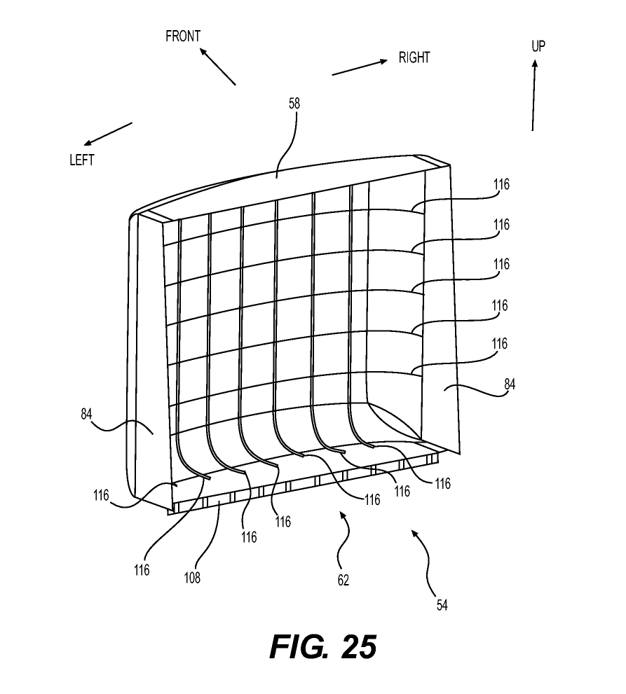

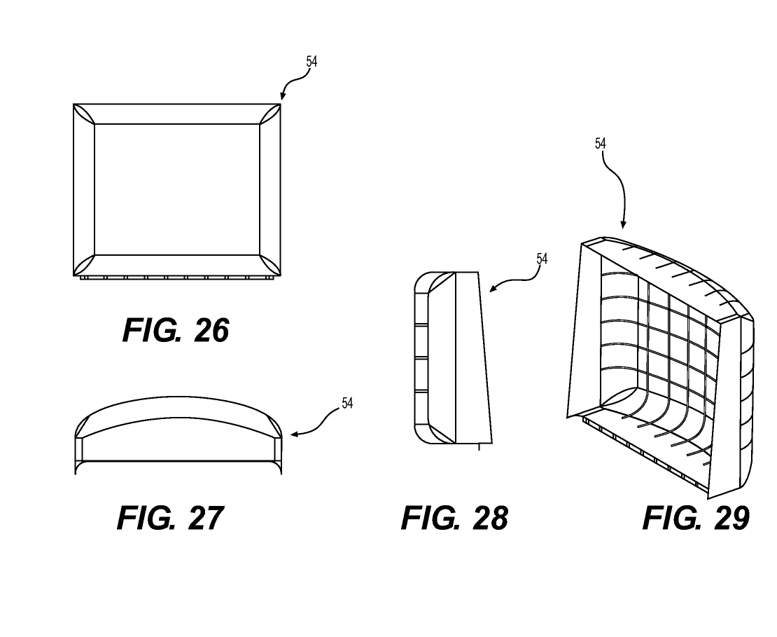

Moving now to FIG. 25 illustrating an embodiment with a plurality of internal ribs 116. The internal ribs 116 are located inside the aerodynamic gap-reducer 54 and are generally not visible from the outside. The smooth exterior design of the aerodynamic gap-reducer 54 allow a free flow of air over the aerodynamic gap-reducer 54 and other graphical applications using the smooth surface as base for printing a logo or another design on the aerodynamic gap-reducer 54. The internal ribs 116 can be accompanied with external ribs 92, independent or not from each other, and can be used individually or collectively without departing from the scope of the present application. FIG. 26 throughout FIG. 29 are illustrating the same gap reducer 54 as shown in FIG. 25, with the ribs 116 not visible from the outside, with exemplary approximated dimensions.

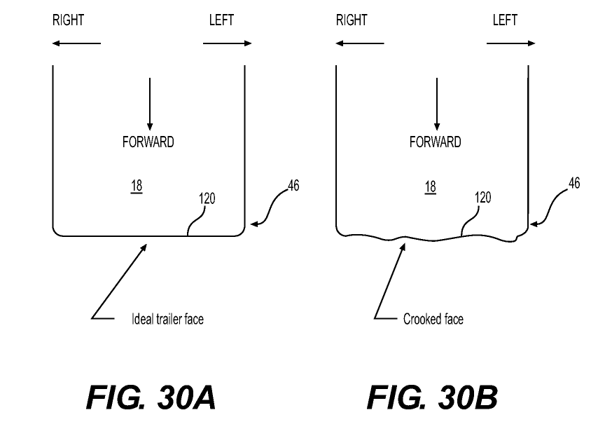

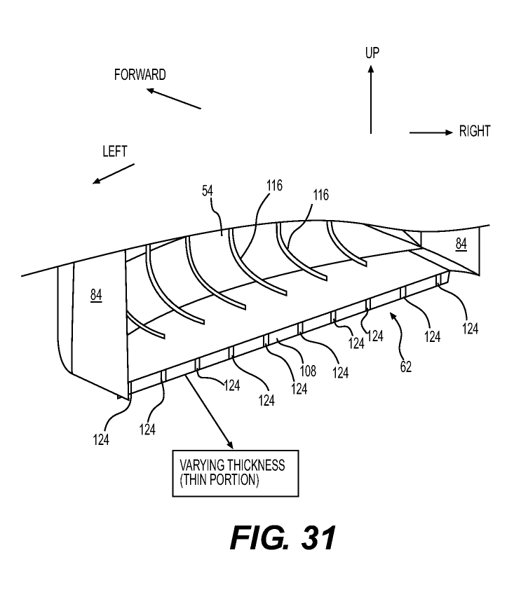

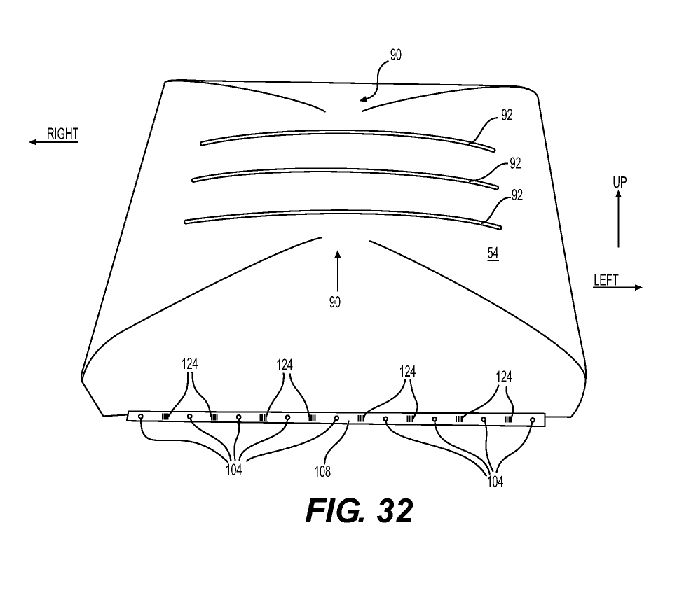

The front portion 46 of a trailer 18 can be damaged and the front face wall 120 thereof can be crooked as illustrated in FIGS. 30 a) and 30 b). The flange 108 located at the bottom portion 62 of the gap-reducer 54 is disposed parallel with the front face wall 120 and is configured to be secured thereto. The flange 108 can be thinner and optionally include varying thickness portions 124 to further help follow the contour of the front face wall 120 of the trailer 18. The varying thickness portions 124 can alternatively be embodied as thinner portions, slotted portions, flexible portions or local modifications in the material, among other possible variations. The varying thickness portions 124 are visible in FIG. 31 and FIG. 32. The varying thickness portions 124 can alternate with portions adapted to receive fasteners 104.

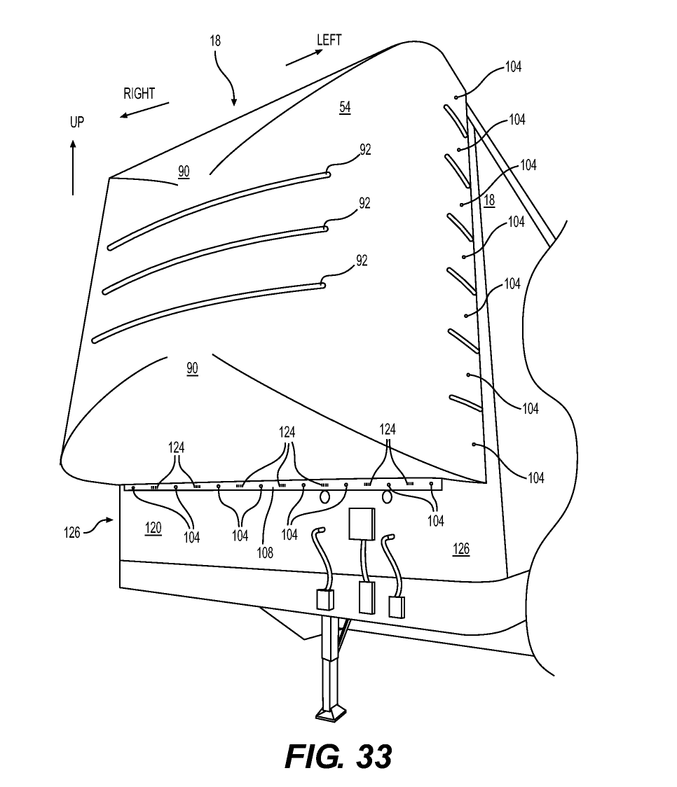

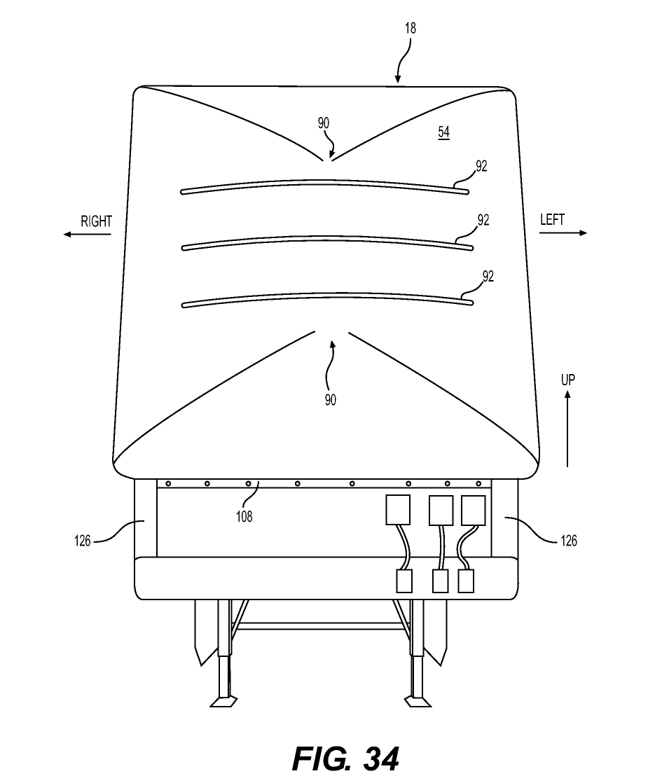

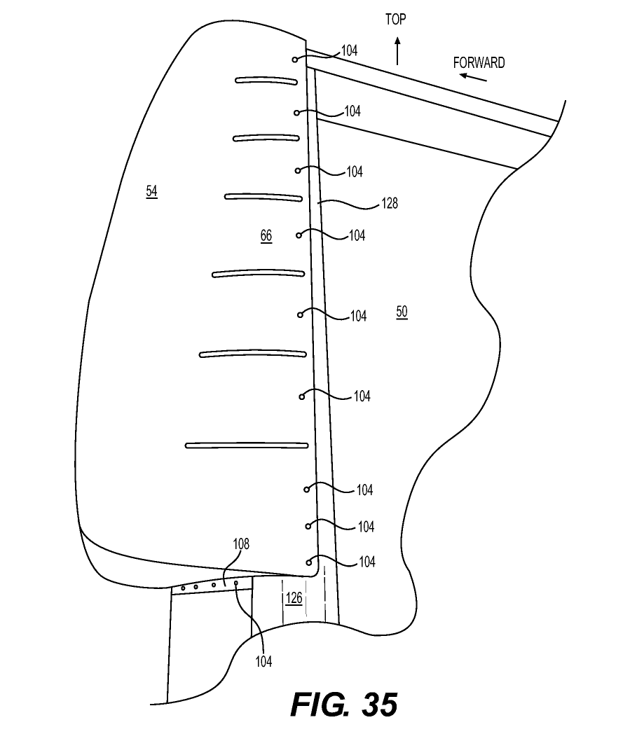

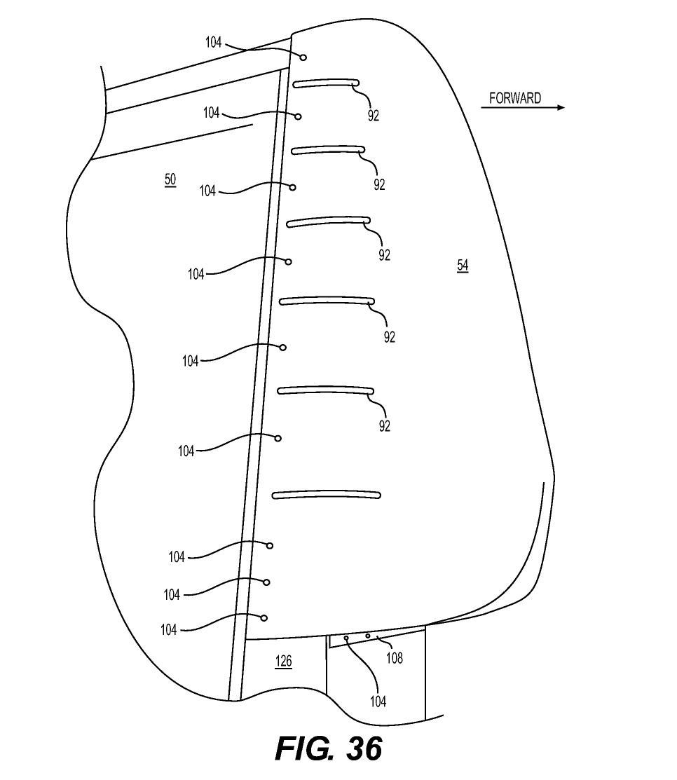

FIG. 33 throughout FIG. 36 are exemplifying the gap-reducer 54 typically installed on a trailer 18. The fasteners 104 securing the side portions 66, 70 of the gap-reducer 54 are secured in a strong corner channel 126 of the trailer 18 for added stiffness and preventing weakening the trailer 18. The, for example, aluminum corner channel 126 can be a simple angle or a radius or a chamfer-like corner depending of the trailer's 18 design.

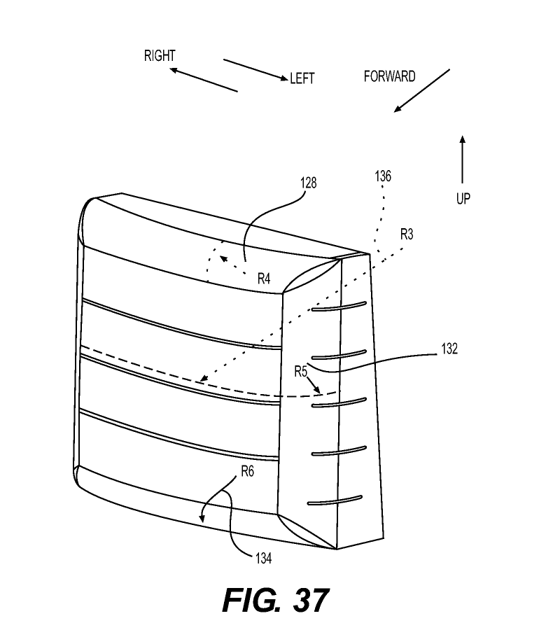

Moving now to FIG. 37 illustrating an aerodynamic gap-reducer 54 with sizes and radiuses design. In a possible embodiment, upper radius 128 is about 10 inches, lower radius 134 is about 25.4 cm (about 10 inches), side radiuses 132 about 38.1 cm (about 15 inches) and central radius 136 of about 330.2 cm (about 130 inches).

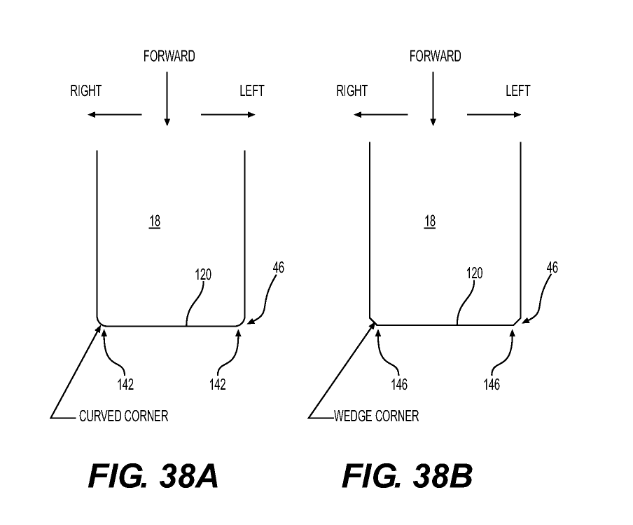

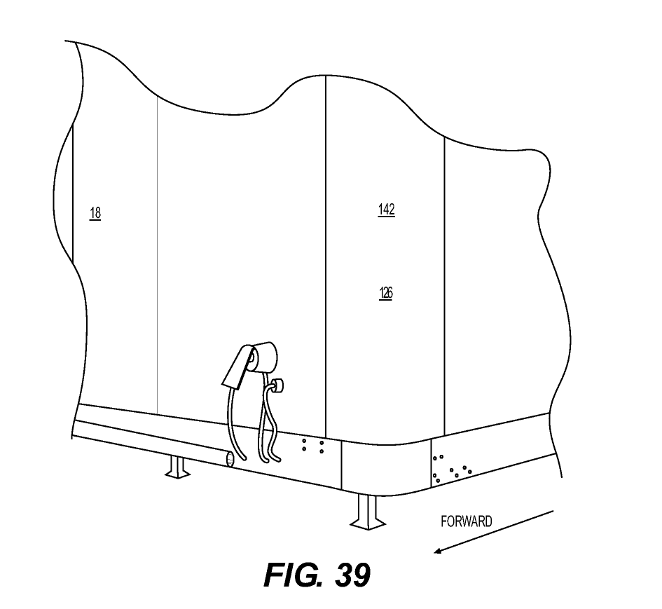

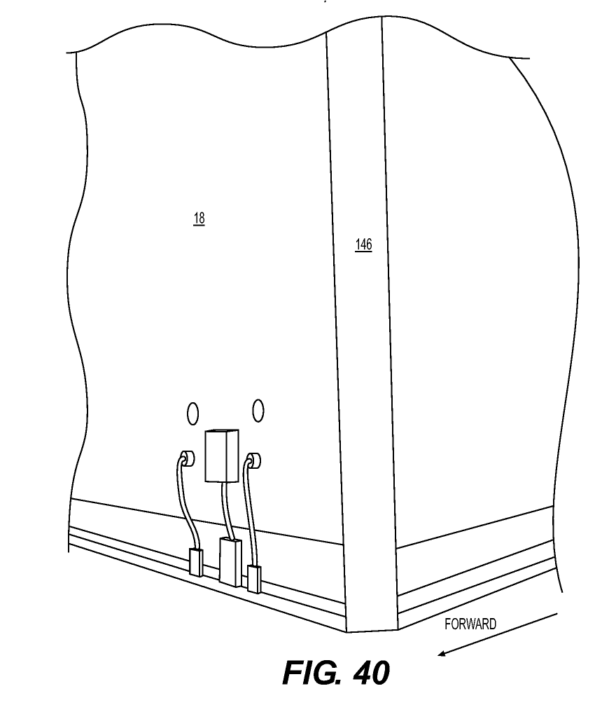

The trailer 18 corners' can have various shapes. Two non-limitative examples are illustrated in FIGS. 38 a) and 38 b), respectively curved corner 142 and wedged corners 146. FIG. 39 illustrates a curved corner 142 on a trailer 18 and FIG. 40 illustrates a wedged/chamfered corner 146 on a trailer 18.

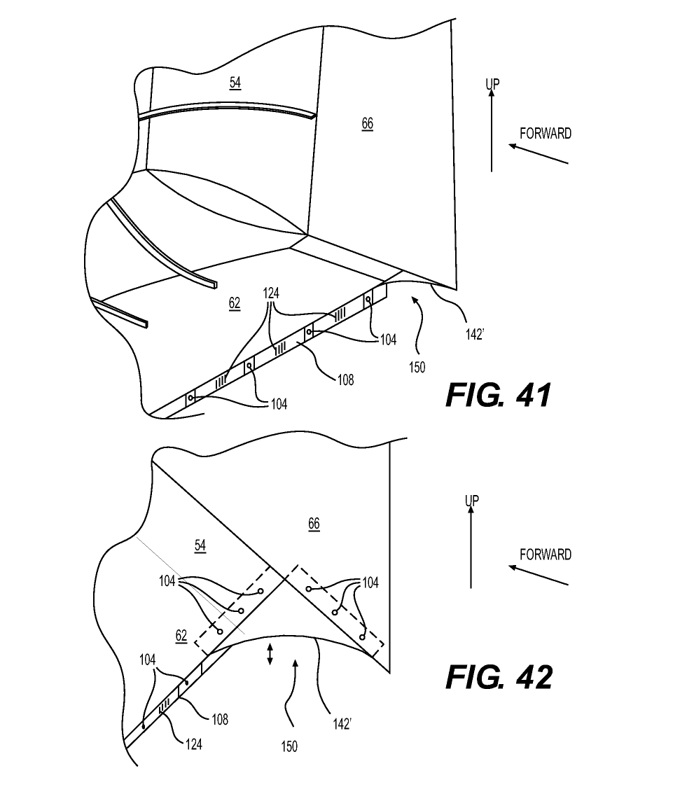

FIG. 41 depicts an embodiment where the matching corners 150 are pre-cut to smallest radius of the curved edge 142 of the trailer. In the present situation a curved matching corner 150 has an edge corresponding to the shape of the trailer 18. The corresponding edge 142′ is shaped in the gap-reducer 54 and is ready to match corresponding curved corner 142 of the trailer 18. Alternatively, FIG. 42 depicts an embodiment where the matching removable modular corner 150 is added on and secured to the aerodynamic gap reducer 54 and the edge 142′ of the modular matching corner 150 is ready to match the shape of the corresponding corner 142 of the trailer.

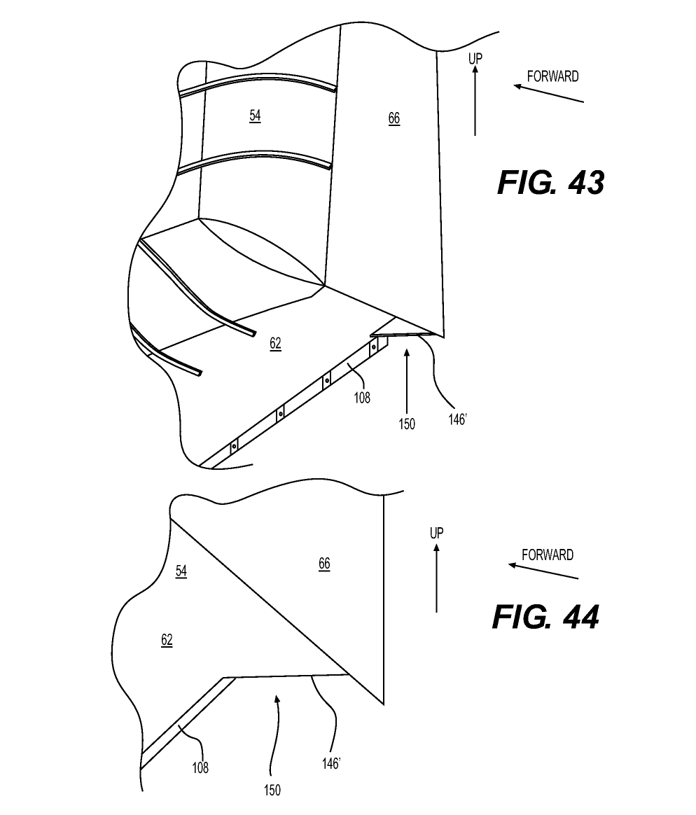

FIG. 43 depicts an embodiment where the matching corners 150 are pre-cut to smallest shape of the edge 146 of the trailer. In the present situation a curved corner 146′ is shaped in the aerodynamic gap-reducer 54 and is ready to match corresponding corner 146 of the trailer 18. FIG. 44 depicts an embodiment where the matching removable modular matching corner 150 is shaped with wedge 146′, is added onto the aerodynamic gap reducer 54 and is ready to match corresponding wedged corner 146 of the trailer 18. Alternatively, modular replaceable matching corners 150 or different designs are sold as separate parts, or as a “matching kit” offering to adapt a generic aerodynamic gap-reducer 54 to a plurality of trailer 18 shapes.

FIG. 44 depict an embodiment where the matching corner 150 is pre-cut to a particular design. In the present situation a wedged corner 146′ is shaped in the gap-reducer 54 and is ready to match corresponding wedged corner 146 of the trailer 18.

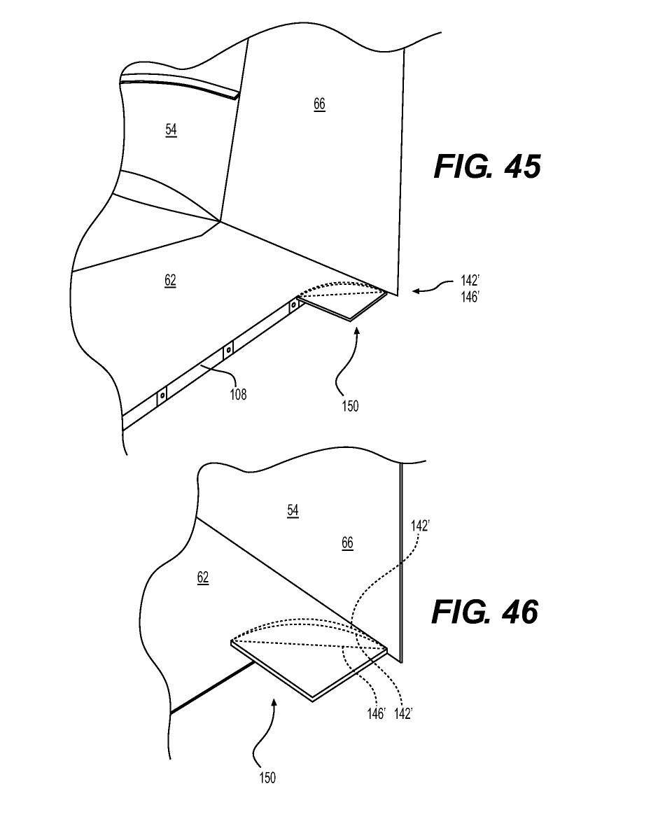

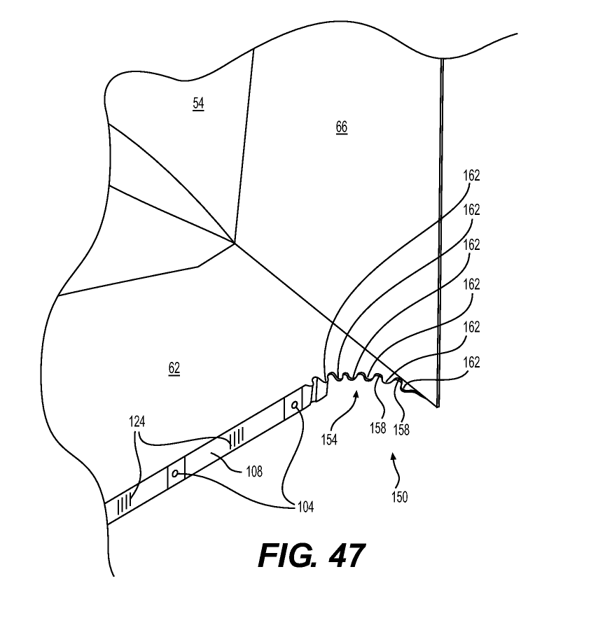

FIG. 45 and FIG. 46 depict an embodiment where the matching corners 150 are pre-marked, or partially cut, with one or a plurality of particular shapes to match a variety of trailer 18 designs. In the present situation a wedged corner 146′ and two different curved corners 142′ are pre-marked or pre-cut in the gap-reducer 54. The corners 150 just have to be adjusted to the desired shape in order to match the trailer's 18 corners 142, 146 shape. An additional embodiment of the matching corners 150 is depicted in FIG. 47. The matching corner 150 includes a pre-cut pattern 154 embodied with a series of cavities 158 facilitating the removal of portions of the matching corners 150 by simply cutting the extending portions 162 to the right dimensions. Each extending portions 162 can be sectioned with a tool such as a small reciprocating saw or the like.

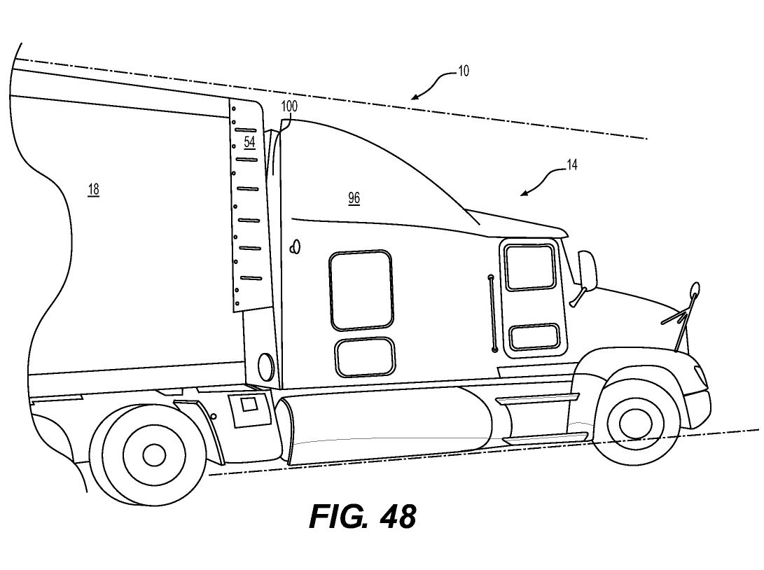

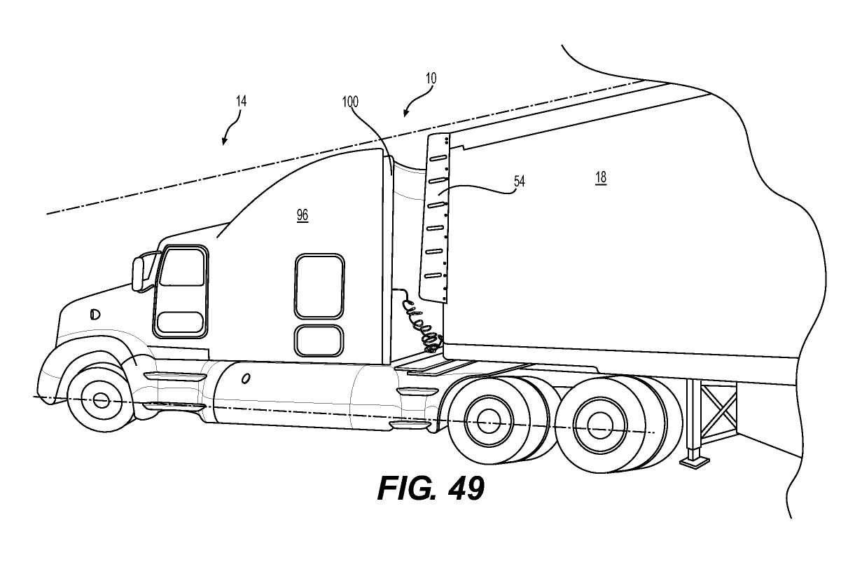

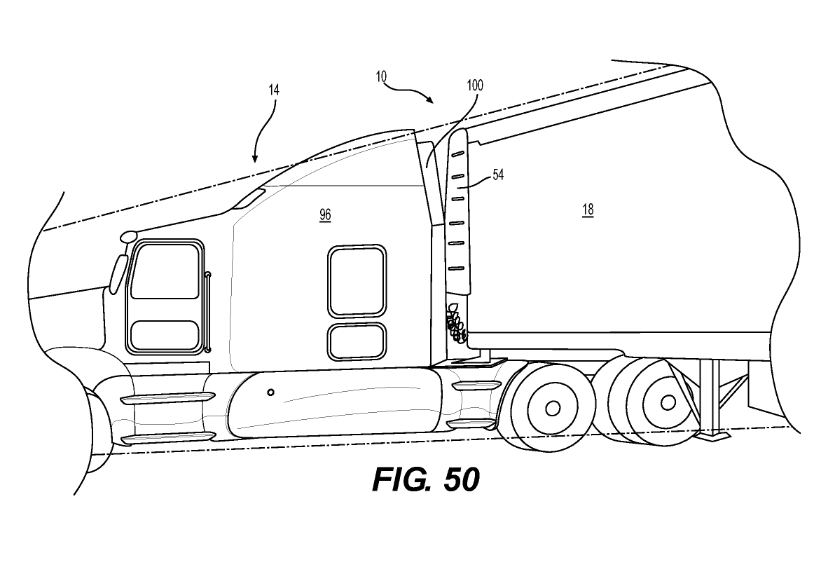

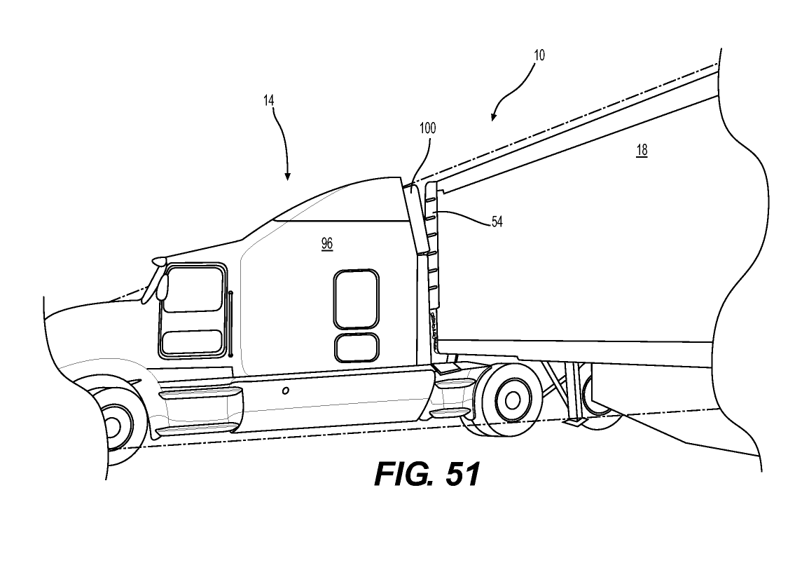

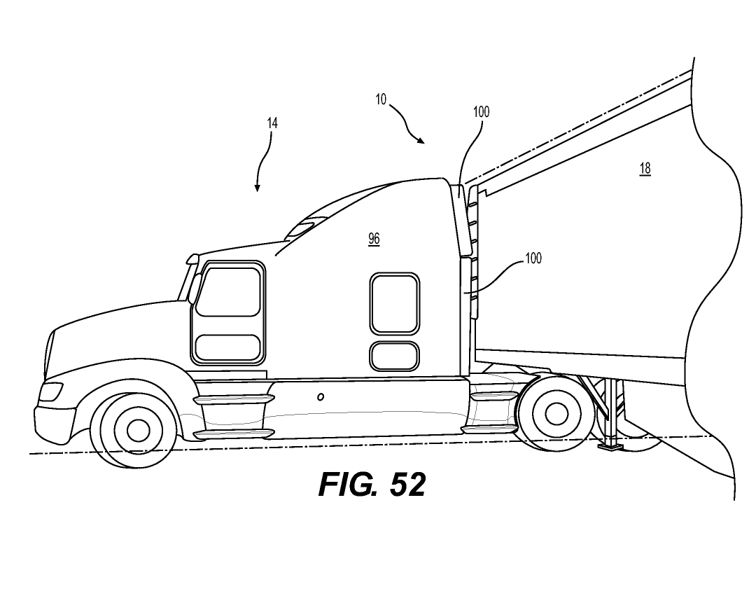

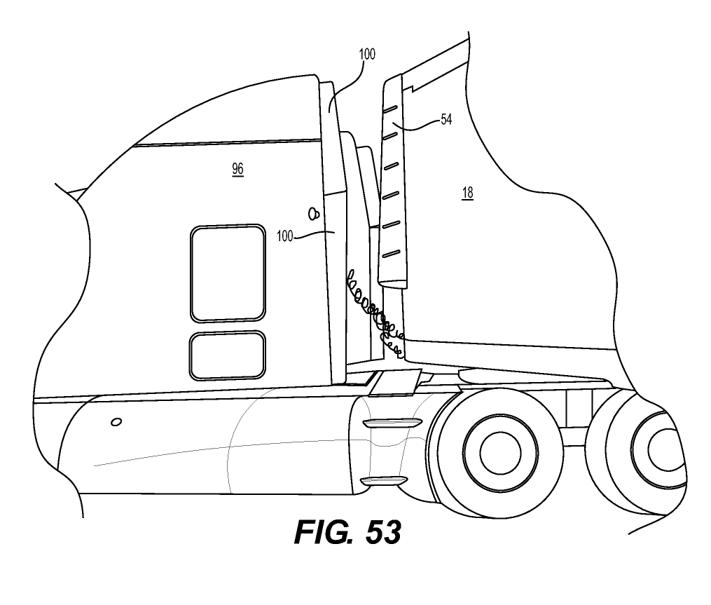

FIG. 48 throughout FIG. 53 are illustrating the cooperation between a road tractor 14 and attached trailer 18 equipped with a gap-reducer 54. These Figures are illustrating a progressive vehicle 10 turn to appreciate the relative movement between the road tractor 14, the sleeper 96, the wind fairing 100, the trailer 18 and the aerodynamic gap-reducer 54. It can also be noted how the gap-reducer 54 gets forward inside the sleeper 96 and the wind fairing 100 to effectively catch and manage the airflow around the vehicle 10 without interfering with the movements of the trailer 18 and the road tractor 14. Seen from the side, the aerodynamic gap-reducer 54 extends further in front than the rear part of the sleeper 96 and/or the wind fairing 100 and still allow tight turns.

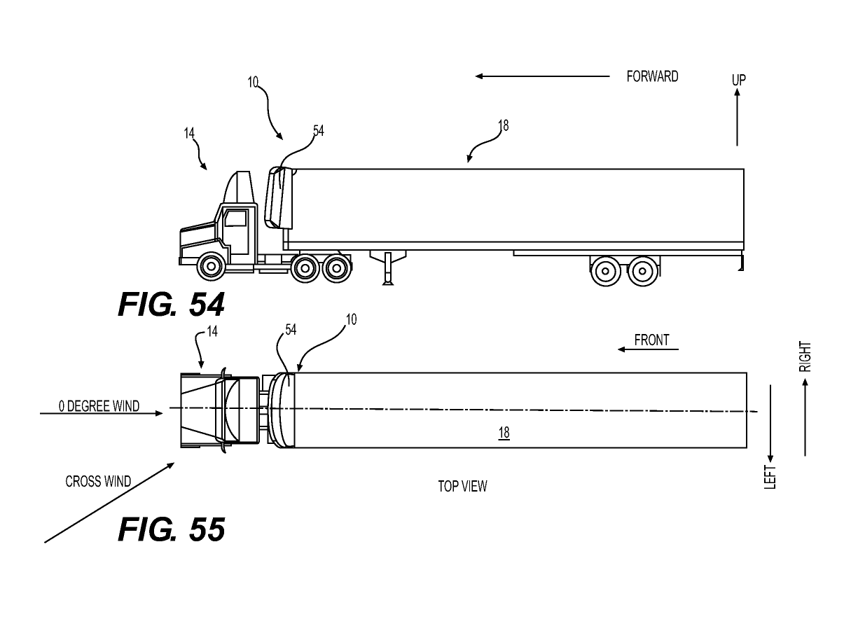

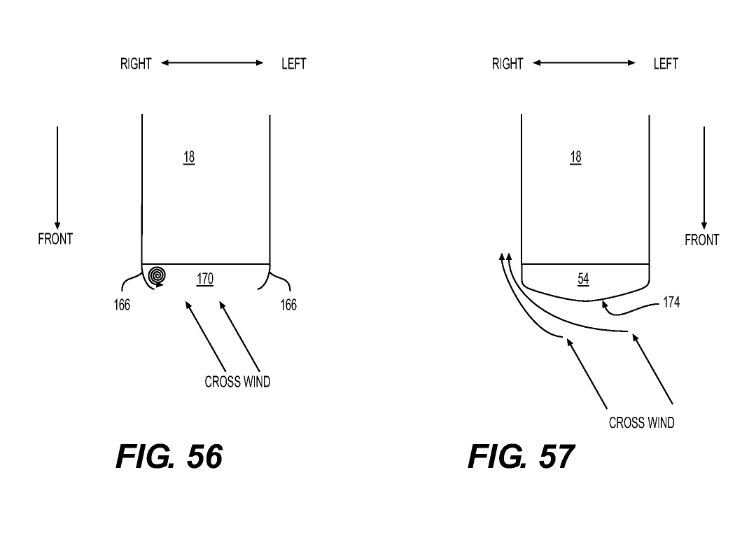

A vehicle 10 is illustrated in FIG. 54 and in FIG. 55 with a typical cross wind. The cross wind effecting the vehicle 10 with wind directed to the vehicle 10 at an angle different of zero (0°) degree in respect with the longitudinal axis of the vehicle 10. FIG. 56 illustrate a prior art front aerodynamic fairing 166 including an opened central portion 170 in which cross wind entering between the tractor 14 (not illustrated) is getting trapped in the opened central portion 170 and creates additional turbulences likely to increase the drag of the vehicle 10. This phenomenon is illustrated in FIG. 41 with a cross wind coming from the left. The same phenomenon can occur with a cross wind coming from the right. In contrast, the gap reducer 54 of the present invention includes a closed volume and the central portion 174 of the gap reducer 54 channels more efficiently and in a more laminar fashion cross winds toward the side of the trailer 18 thus creating less drag and increasing the fuel economy of the vehicle 10.

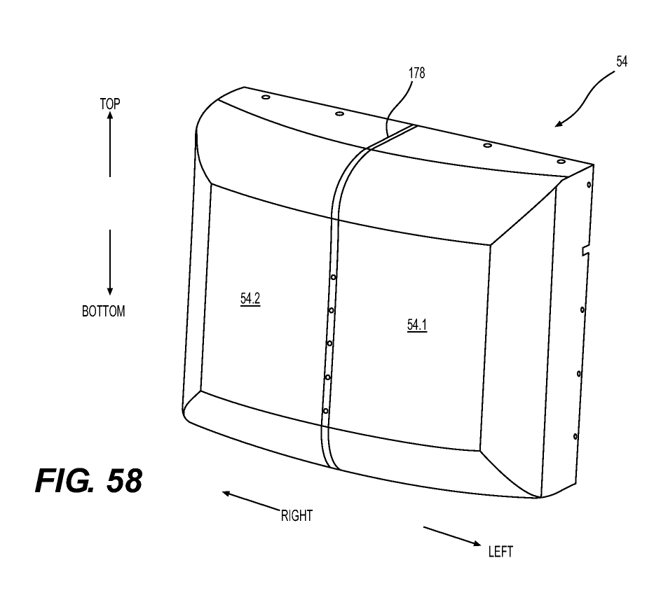

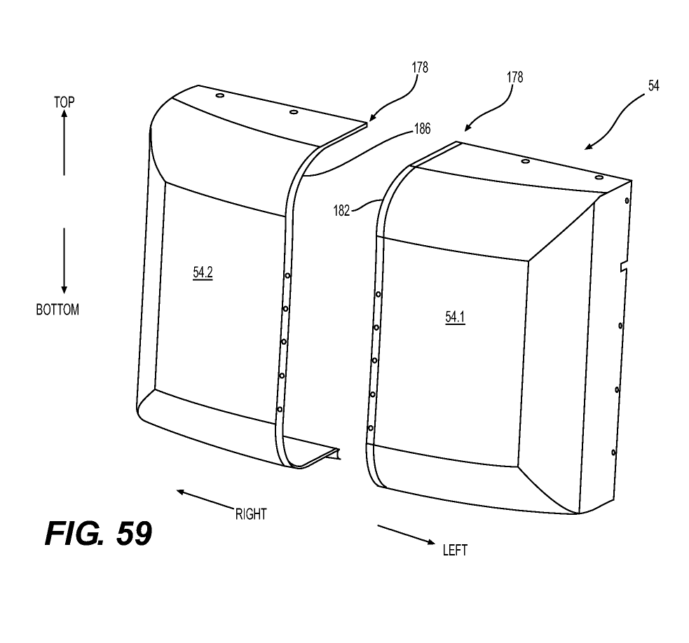

Finally, FIG. 58 and FIG. 59 are illustrating an additional embodiment of the gap reducer 54. The gap reducer 54 has a significant size, can be cumbersome to handle and expensive to ship. The embodied gap reducer 54 is separated in a plurality of parts 54.1, 54.2 sized and designed to be assembled together via a connecting portion 178. The connecting portion 178 is embodied with superposed sections, external section 182 and internal section 186, adapted to be secured with fasteners and result in a smooth and even exterior surface of the gap reducer 54, hence preventing causing turbulences of air flowing about the surface of the gap reducer 54. The connecting portion 178 can be shaped directly in the gap reducer 54 or made with additional parts without departing from the scope of the present application.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

What is claimed is:

1. A gap-reducer for reducing a gap between a road tractor and a trailer attached thereto, the gap-reducer comprising
a top portion;
a bottom portion;
a forward portion between the top portion and the bottom portion; and
a pair of side portions interconnected by the forward portion, the gap-reducer being sized and designed to transversally extend over a width of the trailer and provide the side portions in substantially parallel position with side walls of the trailer.

2. The gap-reducer of claim 1, wherein the side portions are adapted to be secured to the side walls of the trailer.

3. The gap-reducer of claim 2, wherein the pair of side portions are configured to extends over and superpose the side walls of the trailer.

4. The gap-reducer of claim 1, wherein the bottom portion of the gap-reducer is extending forward than the top portion of the gap-reducer when the gap-reducer is secured on the trailer in an operating position.

5. The gap-reducer of claim 1, wherein the forward portion comprises at least one reinforcement rib.

6. The gap-reducer of claim 1, wherein each of the side portions comprises at least one reinforcement rib.

7. The gap-reducer of claim 1, wherein the top portion extends over a ceiling portion of the trailer.

8. The gap-reducer of claim 1, wherein the gap-reducer is made of resilient material adapted to elastically deform from an original shape under an external force applied thereon and to return to the original shape when the external force is not applied anymore thereon.

9. The gap-reducer of claim 1, wherein the side portions comprise a trailing edge and vertically disposed at an angle in respect with the forward portion of the gap-reducer.

10. The gap-reducer of claim 1, wherein the gap-reducer comprises two halves thereof.

11. A trailer comprising a gap-reducer for reducing a gap between a road tractor and the trailer attached thereto, the gap-reducer comprising
a top portion;
a bottom portion;
a forward portion between the top portion and the bottom portion; and
a pair of side portions interconnected by the forward portion, the gap-reducer being sized and designed to transversally extend over a width of the trailer and provide the side portions in substantially parallel position with side walls of the trailer.

12. The trailer of claim 11, wherein the side portions are adapted to be secured to the side walls of the trailer.

13. The trailer of claim 12, wherein the pair of side portions are configured to extends over and superpose the side walls of the trailer.

14. The trailer of claim 11, wherein the bottom portion of the gap-reducer is extending forward than the top portion of the gap-reducer when the gap-reducer is secured on the trailer in an operating position.

15. The trailer of claim 11, wherein the forward portion comprises at least one reinforcement rib.

16. The trailer of claim 11, wherein each of the side portions comprises at least one reinforcement rib.

17. The trailer of claim 11, wherein the top portion extends over a ceiling portion of the trailer.

18. The trailer of claim 11, wherein the gap-reducer is made of resilient material adapted to elastically deform from an original shape under an external force applied thereon and to return to the original shape when the external force is not applied anymore thereon.

19. The trailer of claim 11, wherein the side portions comprise a trailing edge and vertically disposed at an angle in respect with the forward portion of the gap-reducer.

20. The trailer of claim 11, wherein the gap-reducer comprises two halves thereof.
